(19) United States
(12) Patent Application Publication
(10) Pub. No.: US 2012/0228893 A1
(43) Pub. Date: Sep. 13, 2012

(54) Vehicle bed extender

(76) Inventors: Kewang Lu, Dover, DE (US); Rodney Erbe, Rochester, MI (US); Dazhi Lu, San Diego, CA (US); Wei Hai Kong, Kunming (CN)

(21) Appl. No.: 12/932,878

(22) Filed: Mar. 8, 2011

(51) Int. Cl. B62D 33/08

(52) U.S. Cl. 296/26.11

(57) ABSTRACT

The present invention relates to a bed extender for extending and enlarging the carrying capacity of the bed of a pickup truck and some SUV pick-up style vehicles. The extender comprises of a tailgate containing two lateral side panels and a foldable bottom panel. The tailgate is pivotally attached on a U-shape frame which is fixed on supporting beams. The supporting beams are connected to the vehicles main beams underneath the vehicle bed through brackets and can horizontally move out and move in when needed.

### FIELD OF THE INVENTION

The present invention relates to a bed extender for extending and enlarging the carrying capacity of pick-up truck and SUV pick-up style vehicle.

### BACKGROUND OF THE INVENTION

Pick-up trucks and some SUV pick-up style units have forward cabs and rear beds that are generally designed to haul a wide range of cargo. With the increasing use of such vehicle for personal transportation, cab designs have become larger and extended for increased passenger space. Such larger cab designs generally crowd into and limit the bed or cargo space. With such reduced bed space and the ever-increasing demand for further increasing the bed space to accommodate more cargo, a new and improved supplemental cargo space extender is needed. Prior bed-extender designs have generally not met new and higher standards and requirements of increased amounts of cargo or are not practical. Various truck bed extenders, their characteristics, and their uses have been discussed in U.S. Pat. Nos. 5,456,511; 5,669,654; 5,741,039; 5,997,066; 6,283,525; 6,561,560; 6,609,734; 7,226,100; 7,571,947; Of all the above mentioned inventions, the extending range of all the designs are limited to the height of the tail gate, that is they all remain within the laid down tailgate edge. No one has extended beyond the length of the tailgate. Hence the extended cargo space is limited and restricted. In the U.S. Pat. No. 5,924,735, the bed extender consists of two adjustable braces and a tailgate. The whole device needs to be put on and bolted to the side of the bed when in use. when it is not in use, it will be dismounted from the truck and stored elsewhere.

### SUMMARY OF THE INVENTION

The present invention overcomes the disadvantages of the prior known cargo bed extensions by providing an extendable embodiment of the cargo bed which maintains the structural integrity of the vehicle even upon extension. The extension embodiment is anchored in the tailgate, there is no need to continuously install or remove it, or the need to store it elsewhere when not in use. The extension capacity is beyond the length of the lowered vehicle tailgate.

The present invention comprises an extendable embodiment which is composed with two side panels and a foldable floor panel stacked in the tailgate. The tailgate is hinged to a U-shape frame which is connected with two supporting beams that is telescopically attached to main body of the vehicle. The supporting beams are slides supported by brackets and rollers incorporated to vehicles main beams underneath the vehicle.

An enclosed space is constructed for expanded carrying capacity by pulling the tailgate which is hinged to a U-shape frame that is connected with two supporting beams to the extended position; open the side panels in the tailgate to attach to the rear pillars of the bed and lower the floor panel to the floor position.

Other objects, features and advantages of the invention will be apparent from the following description taken in connection with the accompanying drawings.

### BRIEF DESCRIPTION OF THE DRAWINGS

The present invention will be more fully understood by reference to the following detailed description of a preferred embodiment of the present invention when read in conjunction with the accompanying drawing:

FIG. 1 is a perspective view of a vehicle body with extendable cargo space at extended position and the tailgate at horizontal position.

FIG. 2 is a perspective view of a vehicle body at un-extended position.

FIG. 3 is a perspective view of a vehicle body with extendable cargo space at extended position and the tailgate at closed position.

FIG. 4 is a rear view of the extendable tailgate with supporting beam and horizontal part of U-shape frame.

FIG. 5 is an inside view of the tailgate with latches locking the two side panels together when they are in the closed position.

FIG. 6A is a cross-section view of the extended tailgate depicting the folded side panel and two folded floor panels resting inside the tailgate.

FIG. 6B is a cross-section view of the extended tailgate depicting the two long side panels and the three folding floor panels resting inside the tailgate.

FIG. 7 is a side view of extended tailgate with a portion removed for depicting one side panel connected to rear pillar of the vehicle.

FIG. 8A is a side view of extended tailgate with a portion removed for depicting side panel connected to rear pillar and the two fold floor panels extending to the floor position.

FIG. 8B is a side view of extended tailgate with a portion removed for depicting the two fold side panel connected to rear pillar and the three folding floor panel extending to the floor position.

FIG. 9 is an exploded view of the panel hinges of floor panels.

FIG. 10 is a perspective view of the hinges of the side panel.

FIG. 11A is depicting supporting beams and brackets underneath the vehicle bed.

11A-1 is a cross section view of the supporting beam in the bracket which attached to the main beam of the vehicle.

11A-2 is a side view of the supporting beam at extended position.

FIG. 11B is depicting supporting beams underneath the vehicle bed with roller support.

11B-1 is a cross section view of the supporting beam in the bracket with a roller attached to the main beam of the vehicle.

11B-2 is a side view of the supporting beam on rollers at extended position.

FIG. 12 is an exploded cross section view of L-shaped side panel and the floor panel.

FIG. 13 is top view of the steps of the bed extension.

13-1 the tailgate is at original position.

13-2 the tailgate is pulled out to its extended position.

13-3 the side panels opened to attach to the side of the vehicle.

13-4 the floor panel opened to the floor position.

FIG. 14 is a side view of the vehicle. (I used the Hummer truck)

FIG. 15 is a side view of the vehicle with supporting beam and tailgate at extended position.

FIG. 16 is a side view of the vehicle depicting tailgate at extended position and side panel opened and attached to the rear of the bed.

FIG. 17 is a side view of the vehicle with a portion removed for depicting the floor panel moving to the floor position.

FIG. 18 is a side view of the vehicle with extended bed and the tailgate at horizontal position.

### DETAILED DESCRIPTION OF EMBODIMENT OF THE PRESENT INVENTION

In the following description, numerous specific details are set forth. However, it is understood that embodiments may be practiced without these specific details. In other instances, well-known structures and techniques have not been shown in detail in order not to obscure the understanding of this description.

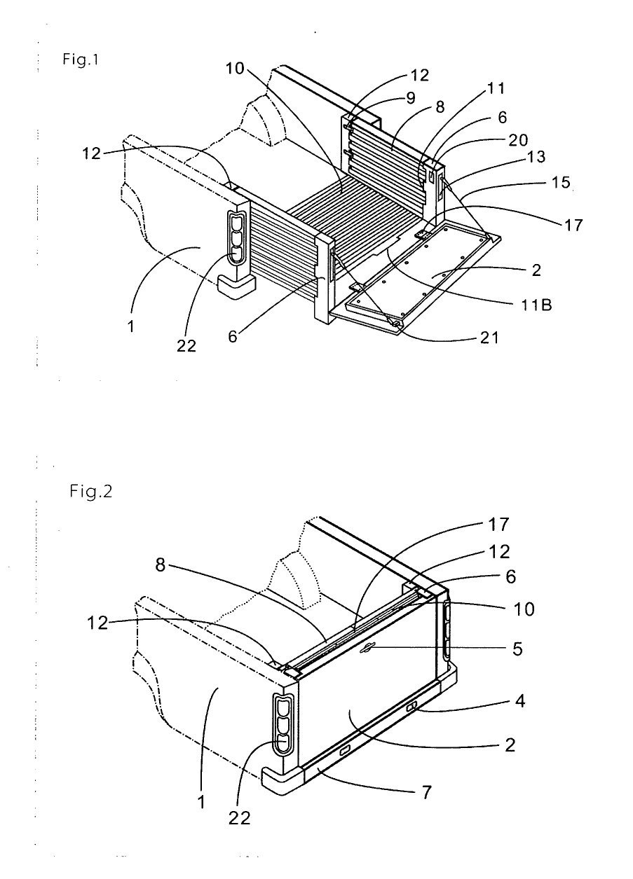

Referring to FIG. 1, there is shown a vehicle body 1 with tailgate 2 at extended leveled position for easy cargo loading , whereas the side panels 8 are connected with the vertical arms 6 of U-shape frame 6 and 7 and by hinge 11 are at opened position; the front end of the side panel 8 is attached to the rear pillar 12 of the vehicle body 1 by latches 9; the floor (bottom) panel 10 attached to the horizontal part 7 of the U-shape frame 6 and 7 by hinges 11B; the tailgate 2 is at horizontal position, supported by supporting cables 15; FIG. 1 also shown the locking members of the tailgate, the slots 20 at the upper part of vertical arm 6 of the U-shape frame 6 and 7 and the tong 19 at the top side of the tailgate 2.

Referring to FIG. 2, there is shown a vehicle body cargo at un-extended position, the tailgate 2 is against the rear pillar 12 of the vehicle body 1; whereas the top part of the tailgate 2 is removed to show the side panels 8 and bottom panels 10 folded in the tailgate. it also shown the hinge 17 connecting the two pieces of the bottom panel 10; FIG. 2 also shown the tailgate 2 resting on the horizontal beam 7 of the U-shape frame with two pulling handles 4 at outside; the locking member's handle 5 is at the central upper part of the tailgate.

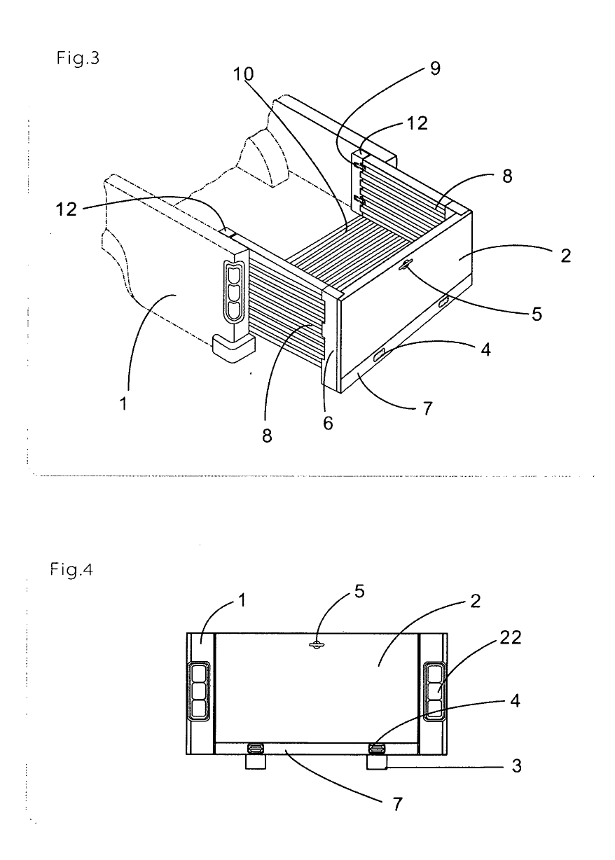

Referring to FIG. 3, there is shown a vehicle body with extended cargo space at extended position and the tailgate 2 is at closed position. Whereas the side panels 8 are connected with the vertical arms 6 of U-shape frame 6,7 and opened; the front end of the side panel 8 is attached to the rear pillar 12 of the vehicle body 1 by latches 9; the floor panel 10 is extended to horizontal position. FIG. 3 also shown the locking members handle 5 of the tailgate, the pulling handles 4 of the U-shape frame 6, 7.

Referring to FIG. 4, there is shown a rear view of vehicle tailgate 2 resting on the horizontal beam 7 of the U-shape frame with the pulling handles 4; the tailgate 2 is flush with the vehicle body 1; the U-shape frame is permanently fixed on the supporting beams 3.

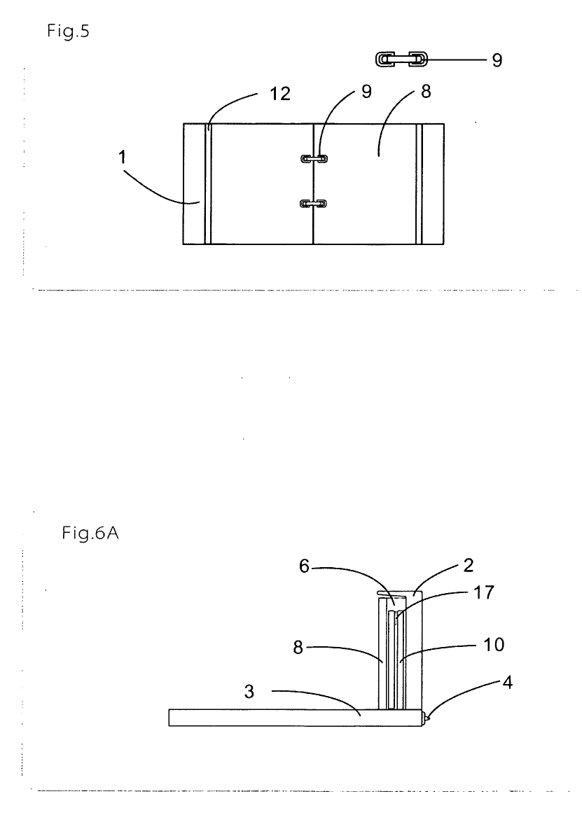

Referring to FIG. 5, there is shown an inside view of the tailgate with latches 9 connecting the side panels 8 together when they are in closed position. The tailgate is against with rear pillar of the vehicle body.

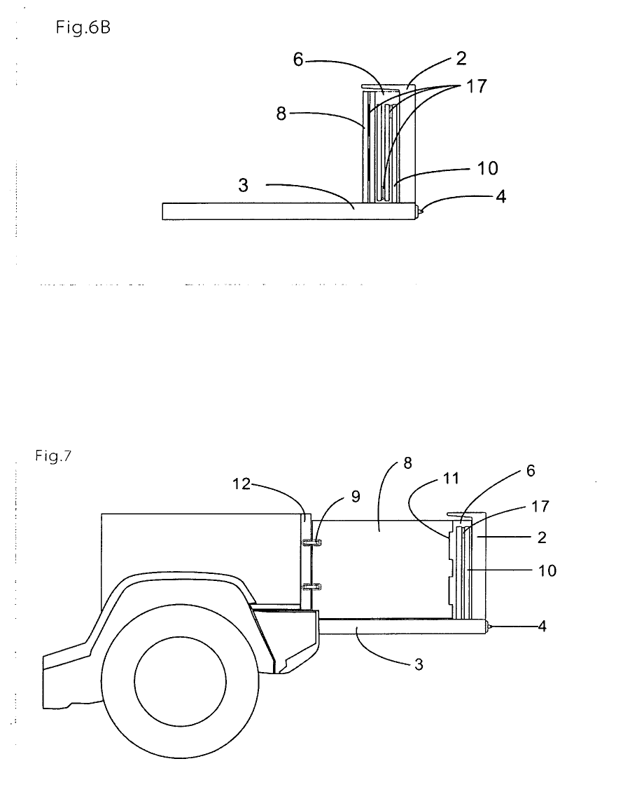

Referring to FIG. 6A, there is shown a cross-sectional view of supporting beam 3 at extended position, with side panel 8 attached to the vertical arm 6 of U-shape frame and floor panels 10 folded in the tailgate 2. The two floor panels are joined with panel hinge 17 wherein the side panels 8 is one piece and floor panel 10 is two pieces.

Referring to FIG. 6B, there is shown a cross-sectional view of supporting beam 3 at extended position, side panel 8 and floor panel 10 folded in the tailgate 2. Side panels are two pieces (joined with panel hinge 17) and floor panels are three pieces (joined with panel hinge 17) for accommodating extra big capacity of the cargo space.

Referring to FIG. 7, there is shown a side view of extended bed with a portion removed to show the side panel 8 attached to the rear pillar 12 of vehicle body side 1 with latches 9; the supporting beam 3 is pulled out by pulling the handle 4 to the extended position wherein the tailgate 2 is at vertical position; the side panel 8 is connected with the vertical arm 6 of the U-shape frame by hinge 11; the floor panels 10 are still folded within the tailgate.

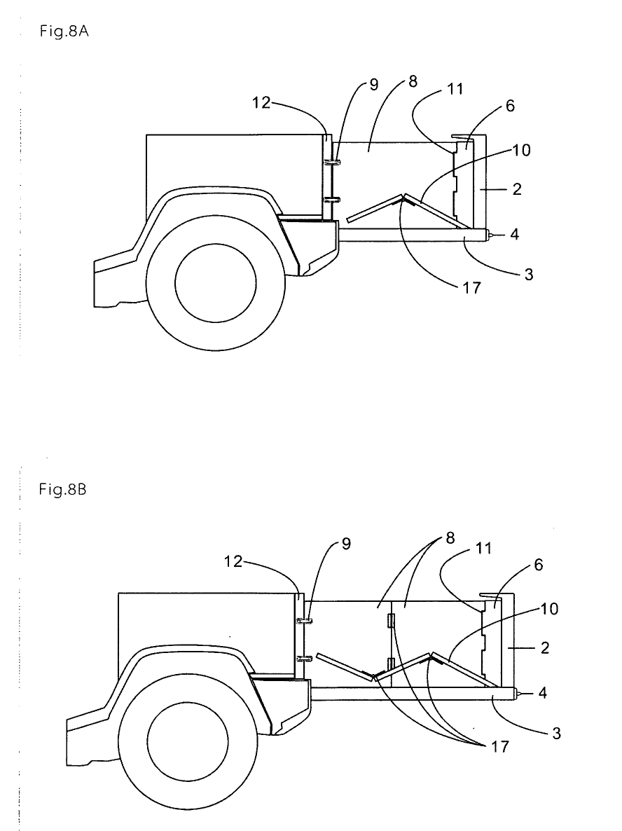

Referring to FIG. 8A, there is shown a side view of extended bed with a portion removed to show the side panel 8 attached to the rear pillar 12 of vehicle body side 1 with latches 9; the supporting beam 3 is pulled out by pulling the handle 4 to the extended position wherein the tailgate 2 is at closed position; the side panel 8 is connected with the vertical arm 6 of the U-shape frame by hinge 11; the floor panels 10 is extending to be rested on the supporting beam 3.

Referring to FIG. 8B, there is shown a side view of extended bed with a portion removed to show the longer (two folded) side panels 8 attached to the rear pillar 12 of vehicle body side 1 with latches 9; the supporting beam 3 is pulled out by pulling the handle 4 to the extended position wherein the tailgate 2 is at closed position; the side panels 8 is connected with the vertical arm 6 of the U-shape frame by hinge 11; The three folded floor panel (connected with panel hinge 17) is extending to be rest on the supporting beam 3. Therein the side panel is two pieces and the floor panel is composed of three pieces for accommodating extra long object for the cargo.

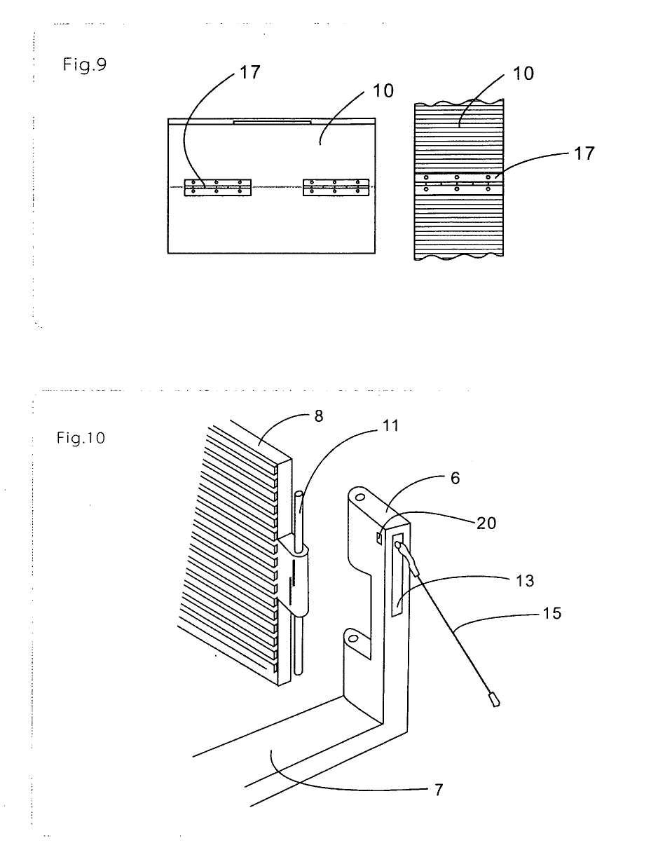

Referring to FIG. 9, there is shown an exploded view of floor panel 10 structures, the two panels are connected by panel hinges 17.

Referring to FIG. 10, there is shown a view of the hinge 11 for the side panels 8 structure.

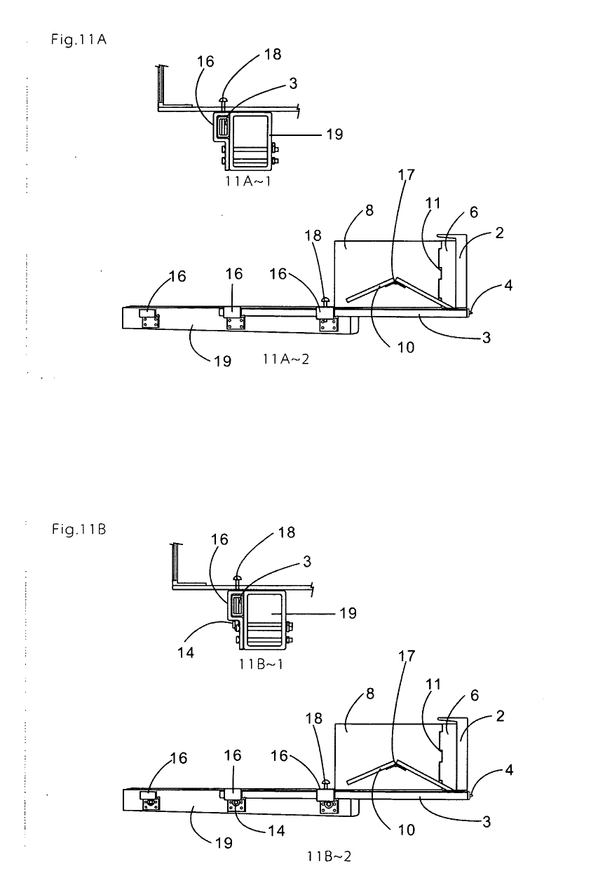

Referring to FIG. 11, 11A-1 there is shown a cross section view of supporting beam 3 attached to the main beam 19 of the vehicle by brackets 16. The supporting beam 3 is secured by securing pin 18.

11A-2 there is shown a side view of extended bed with a portion removed to show the supporting beam at extended position the side panel is opened and the floor panel is extending to the floor position.

Referring to FIG. 11B, 11 B-1 there is shown a cross section view of supporting beam 3 attached to the main beam 19 of the vehicle by brackets 16. The supporting beam 3 is supported by roller 14 and secured by securing pin 18.

11B-2 there is shown a side view of extended bed with a portion removed to show the supporting beam 3 at extended position and supported by rollers 14 and secured by pin 18, the side panel is opened and the floor panel is extending to the floor position.

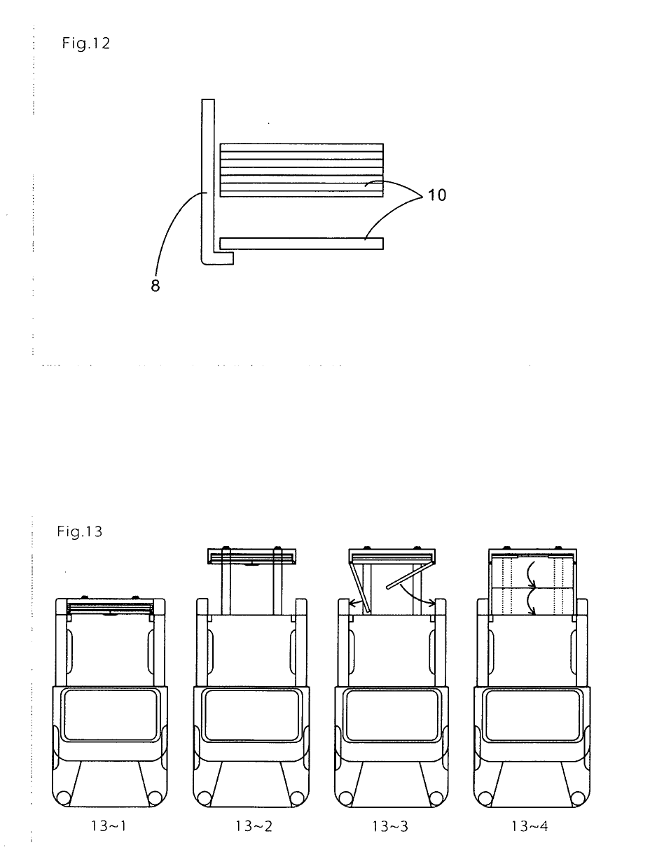

Referring to FIG. 12, there is shown the L-shaped side panel 8 supporting the edge of floor panel 10.

Referring to FIG. 13, there are top views of the opening procedures of the extendable bed. 13-I there is shown the truck bed is at un-extended position. 13-2 there is shown the supporting beam is pulled out to extended position; 13-3 there is shown the side panels is opening to attach to the side of vehicle; 13-4 there is shown the floor panel is opening to the floor position.

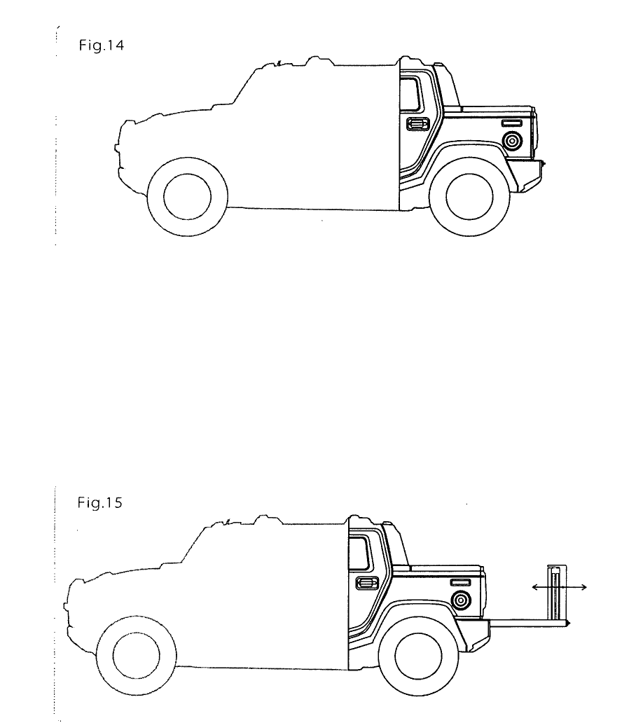

Referring to FIG. 14, there is the side view shown the truck bed is at un-extended position.

Referring to FIG. 15, there is the side view shown the truck bed is at extended position, the side panel and floor panel are still rest in the tailgate.

Referring to FIG. 16, there is the side view shown the truck bed is at extended position; the side panel is opened and attached to the vehicle body side.

Referring to FIG. 17, there is the side view shown the truck bed is at extended position; the side panel is opened and attached to the vehicle body side and floor panel is lowered to the floor position.

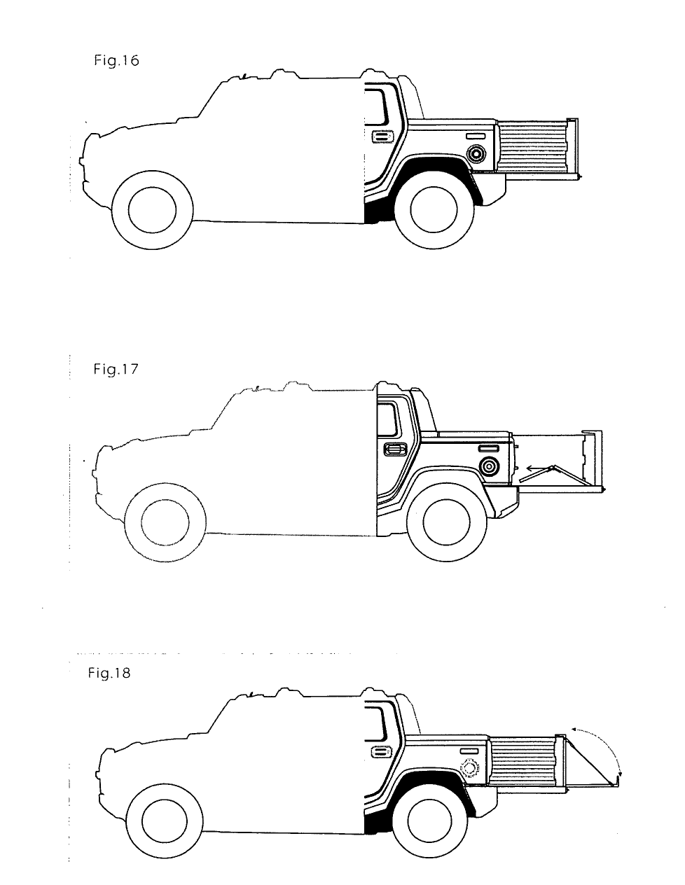

Referring to FIG. 18, there is the side view shown the truck bed is at extended position; the side panel is opened and attached to the vehicle body side and tailgate is at horizontal position.

According to the usage of the vehicles which need accommodating large cargo, the supporting beam could be longer and use two folded side panel and three folded floor panel accordingly. (Refer to FIG. 6B and FIG. 8B)

Rubber or buffering materials could be secured to certain spots of the panels to reduce the fraction and rattling of the side panel and floor panels.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

The lower edge of side panel could be made of L-shaped to support the floor panel.

What is claimed is:

1. A self sustained cargo bed extender of an automotive vehicle for increasing its usable cargo space comprising, in combination:
A tailgate containing two lateral side panels and foldable bottom panels. The panels are folded inside the tailgate when not in use.
A pair of supporting beams which are connected to the vehicle's main beams underneath the vehicle bed through brackets and can horizontally move out and move in as needed.
An U-shape frame, of which the horizontal part is fixed at the outer end of supporting beams; the two vertical arms are secured to the existing side of the vehicle bed by lock (latch, or other mechanisms).
A tailgate containing side and bottom panels, the lower end of the tailgate is connected with the horizontal part of the U-shape frame by hinges. The upper part of the tailgate is locked to the two vertical arms of the U-shape frame by latches (or other mechanisms) on both sides.
A tailgate contains side and bottom panels. The lateral panels connected at the side of vertical arms of the U-shape frame by hinges. When the supporting beams are pulled out at extended position, the side panel swing forward and attach to the rear pillar of the vehicle body by latches, pins, brackets or other fixing apparatus to form the two sides of the extended cargo space.
A tailgate containing side and bottom panels, one side of the bottom panel is connected with the horizontal part of the U-shape frame by hinges. The foldable bottom panel is two folds or three folds to accommodate the need of extension. When the supporting beams are pulled out at extended position, after the side panel opened and attached, the bottom panel is pulled forward and lay on the supporting beams to form the bottom of the extended cargo space.
A tailgate containing two lateral side panels wherein the lower end of the two side panels is bent to an L-shape for stabilizing the extended cargo space and supporting both sides of the bottom panels.
A tailgate containing lateral and bottom panels, when the tailgate is positioned at the extended position with side panel and bottom panel opened, the tailgate can be leveled horizontally for easy cargo loading.
